(19) United States
(12) Patent Application Publication
(10) Pub. No.: US 2024/0071039 A1
(43) Pub. Date: Feb. 29, 2024

(54) METHODS AND APPARATUS FOR COMPUTATION AND COMPRESSION EFFICIENCY IN DISTRIBUTED VIDEO ANALYTICS

(71) Applicant: Intel Corporation, Santa Clara, CA (US)

(72) Inventors: Nagabhushan Eswara, Bangalore (IN); Jaroslaw J. Sydir, San Jose, CA (US); Vallabhajosyula Srinivasa Somayazulu, Portland, OR (US); Nilesh Ahuja, Cupertino, CA (US); Omesh Tickoo, Portland, OR (US); Parual Datta, Bangalore (IN)

(21) Appl. No.: 18/478,628

(22) Filed: Sep. 29, 2023

(51) Int. Cl. G06V 10/44; G06T 3/00; G06T 3/40; G06T 7/20; H04N 19/172

(52) U.S. Cl. CPC G06V 10/44; G06T 3/0093; G06T 3/4007; G06T 7/20; H04N 19/172

(57) ABSTRACT

Methods and apparatus are disclosed herein for computation and compression efficiency in distributed video analytics. Example apparatus disclosed herein are to identify a key frame and a non-key frame in a video frame sequence input to a neural network at a client server, determine motion information between the key frame and the non-key frame based on optical flow, and determine a frame feature representation based on the motion information reconstructed at an edge server, the motion information including feature warping residual errors.

### FIELD OF THE DISCLOSURE

This disclosure relates generally to software processing, and, more particularly, to methods, systems, and apparatus for computation and compression efficiency in distributed video analytics.

### BACKGROUND

Deep neural networks (DNN) such as convolutional neural networks (CNNs) and recurrent neural networks (RNNs) can be used to provide accurate solutions for problems associated with a variety of fields, including image classification, speech recognition, medical diagnosis, and/or autonomous driving. An increase in the size of input data and a corresponding increase in DNN complexity results in increases in the computational intensity and memory demands of deep learning-based tasks.

### BRIEF DESCRIPTION OF THE DRAWINGS

FIG. 1A is an example of a media analytics pipeline.

FIG. 1B is an example environment in which media analytics is performed using a separation of execution between a client side and a server side.

FIG. 2 illustrates an example distributed media pipeline with a bottleneck module in combination with an example feature warping generator circuitry used for media analytics in accordance with teachings disclosed herein.

FIG. 3 is a block diagram representative of the feature warping generator circuitry that may be implemented in the example environment of FIG. 2.

FIG. 4 is a flowchart representative of example machine-readable instructions and/or example operations that may be executed, instantiated, and/or performed by example programmable circuitry to implement the example feature warping generator circuitry of FIG. 3.

FIG. 5 is a flowchart representative of example machine readable instructions and/or example operations that may be executed, instantiated, and/or performed by example programmable circuitry to implement a computing system of FIG. 4 to cause the first computing system to train a neural network to generate two-stream model(s).

FIG. 6 is a flowchart representative of example machine-readable instructions and/or example operations that may be executed, instantiated, and/or performed by example programmable circuitry to implement the example feature warping generator circuitry of FIG. 3 to identify residual error(s).

FIG. 7 illustrates an example first deep feature warping-based learned semantic video compression pipeline with split deep neural network (DNN) compute and bottleneck modules for compressing deep features.

FIG. 8 illustrates an example second deep feature warping-based learned semantic video compression with split DNN compute.

FIG. 9 illustrates example results for object detection accuracy associated with key frame intervals using methods and apparatus disclosed herein.

FIG. 10 illustrates examples results for average frame size of a combination of key frames, non-key frames and sub-key frames, as a function of key frame interval.

FIG. 11 illustrates example results for object detection accuracy versus compression efficiency when comparing the methods and apparatus disclosed herein to a standards-based compression.

FIG. 12 illustrates example object detection accuracy versus average client-side computational complexity.

FIG. 13 is a block diagram of an example processing platform including programmable circuitry structured to execute, instantiate, and/or perform the example machine readable instructions and/or perform the example operations of FIGS. 4-6 to implement the deep feature warping generator circuitry of FIG. 3.

FIG. 14 is a block diagram of an example processing platform structured to execute the instructions of FIG. 5 to implement the computing system of FIG. 3.

FIG. 15 is a block diagram of an example implementation of the programmable circuitry of FIG. 13.

FIG. 16 is a block diagram of another example implementation of the programmable circuitry of FIG. 13.

FIG. 17 is a block diagram of an example software/firmware/instructions distribution platform (e.g., one or more servers) to distribute software, instructions, and/or firmware (e.g., corresponding to the example machine readable instructions of FIGS. 4, 5 and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

### DETAILED DESCRIPTION

Deep neural networks (DNNs) have revolutionized the field of artificial intelligence (AI) as applied in many domains including computer vision, speech processing, and natural language processing. More specifically, neural networks are used in machine learning (ML) to allow a computer to learn to perform certain tasks by analyzing training examples. For example, an object recognition system can be fed labeled images of objects (e.g., cars, trains, animals, etc.) to allow the system to identify visual patterns in such images that consistently correlate with a particular object label. DNNs rely on multiple layers to progressively extract higher-level features from raw data input (e.g., from identifying edges of a human being using lower layers to identifying initial facial features using higher layers, etc.). For example, convolutional neural networks (CNNs) are widely applied in large-scale computer vision and video recognition applications, including tasks such as style transfer, object tracking, 3D reconstruction, as well as facial and action-based recognition. In some examples, a CNN can be used to receive images as input and use the received images to train a classifier. For example, the CNN can include a convolution layer, a pooling layer, an activation layer, and a fully connected layer for performing feature learning and classification. CNNs used for object detection and image classification include Region-based Convolutional Neural Networks (R-CNN), Fast R-CNN, VGGNet, AlexNet, and Residual Neural Network (ResNet).

In a typical distributed media-analytics framework, video data captured by a camera is compressed using a video codec (e.g., such as H.264/HEVC, etc.) and transmitted over the network to an edge or cloud server where the bitstreams are first decompressed and then provided as input for various analytics tasks (e.g., such as classification, segmentation, tracking, etc.). In recent years, machine-learning through DNNs has significantly improved the accuracy of such tasks. Compression by existing techniques (e.g., MPEG, HEVC, etc.) may not necessarily be optimal for analytic tasks, since such techniques are optimized for perceptual quality, not semantic representation. Consequently, task performance can degrade severely in the presence of even relatively mild compression artifacts. Also, in dense and bandwidth-limited edge networking scenarios the large numbers of users or video streams that must be served drives a need for optimizing the bandwidth efficiency of the visual compression for the different visual analytics tasks, beyond what standard compression techniques can deliver.

Moreover, decoding all the frames and then performing DNN-based visual analytics on each frame incurs a large computational cost and lowers the stream density at the edge-server/cloud (e.g., the number of streams that can be simultaneously processed). Alternate approaches operating on learnt representations from the feature space of a DNN include splitting the DNN at a particular layer and extracting the deep feature representations by the front end or head of the DNN, the deep feature representations compressed and transmitted to an edge server. The remaining layers (e.g., also referred to as the tail) can then decompress these representations and finish the remaining DNN processing. Since the analytics computation is partitioned between the client/mobile device and the edge-server, the computational load on the edge-server is reduced and the stream density at the edge-server increases proportionally. To reduce the volume of data to be transmitted, low complexity bottleneck layers are introduced at the split point, which reduces the dimensions of the features to be compressed and transmitted. The bottleneck module can therefore be viewed as a deep autoencoder that has been designed for the feature space of a deep network.

Other approaches include using leveraged deep feature warping in conjunction with low-complexity, adaptive learned key frame compression to both reduce average client complexity as well as improve compression efficiency for distributed video analytics. For example, in deep feature warping, key frames are frames for which features are generated by feeding the frame image through a backbone network, while non-key frames are frames whose features are generated by warping the features of a previously identified key-frame. The computational complexity and compression efficiency gains are closely linked together based on the key frame interval used for adaptation. Reducing the key frame interval would improve the average analytics accuracy performance, but both the average client complexity and the compression efficiency degrade due to the more frequent key frames. In general, approaches to learned video compression are largely focused on reconstruction for human viewing rather than for semantics-preserving targets. Split-DNN computing with split points in the DNN are not efficient in terms of adaptation to variable computation and compression constraints and in particular do not cover efficient video analytics-based tasks, given that such approaches mainly address the image analytics pipeline. For example, previous approaches have focused on the average total complexity reduction while not focusing on distributed implementations with joint optimizations of compression in combination with complexity. Such solutions suffer from high computational complexity (e.g., as in the case of learned video compression algorithms optimized for semantics-preserving targets). Moreover, such solutions are not optimized for split computing in distributed client-edge-cloud usage scenarios. Furthermore, known approaches do not flexibly adapt average computational complexity in return for compression efficiency. Instead, increased complexity goes along with poorer compression efficiency and vice versa.

Methods and apparatus disclosed herein introduce computation and compression efficiency in distributed video analytics. For example, methods and apparatus disclosed herein introduce an enhanced solution for distributed video-analytics at the edge. Examples disclosed herein leverage dynamic DNN partitioning with variable bit rate compression and motion estimation/optical flow-based processing of the deep feature representations. Furthermore, methods and apparatus disclosed herein improve computational complexity and compression efficiency by adding additional information in the form of warping residual errors. To enhance performance, error residuals can be periodically computed between warped deep features and initial features computed for a particular frame. For such periodic frames (e.g., referred to as sub-key frames in examples disclosed herein), the compression of flow information in combination with the feature warping residuals provides better compression than for the key frames, at the cost of marginally higher complexity (e.g., due to additional flow and warping computation). Such an approach offers a richer tradeoff space over which to optimize computational complexity (e.g., at the client or edge), compression efficiency, and/or task accuracy. Methods and apparatus disclosed herein assist with decoupling compute complexity and compression efficiency tradeoffs and provide enhanced performance over known approaches in terms of accuracy-rate-complexity characteristics.

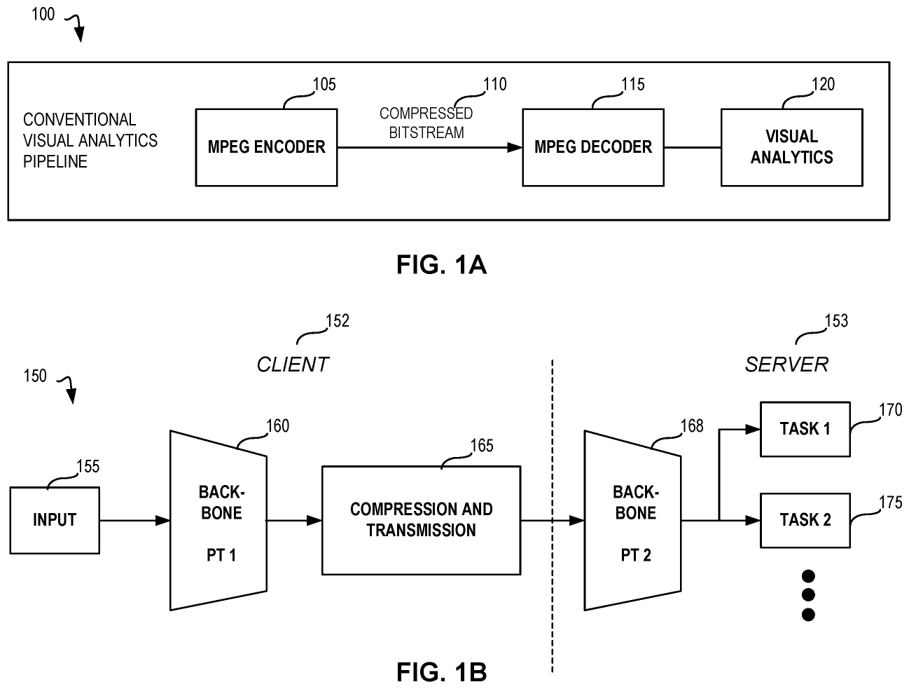

FIG. 1A is an example of a visual analytics pipeline 100. The visual analytics pipeline 100 includes an example Moving Picture Experts Group (MPEG) encoder 105, an example compressed bitstream 110, an example MPEG decoder 115, and example visual analytics 120. For example, video data captured by a mobile device can be compressed using image and video codecs and transmitted over the network to an edge-server. As shown in the example of FIG. 1A, the MPEG encoder 105 compresses the bitstream (e.g., resulting in a compressed bitstream 110) which is received by the MPEG decoder 115. The resulting output can be provided to visual analytics 120 for various analytics tasks, which increasingly are performed by complex DNNs.

FIG. 1B is an example environment 150 in which media analytics is performed using a separation of execution between a client side 152 and a server side 153. The media analytics environment 150 of FIG. 1B includes example input data 155, an example first backbone 160, an example compression and transmission system 165, an example second backbone 168, an example first task 170, and an example second task 175. As shown in the example of FIG. 1B, the DNN (e.g., including the backbone 160, compression and transmission system 165, etc.) is split such that deep feature representations are extracted by a front end of the DNN (e.g., client side 152), compressed, and transmitted to the edge server (e.g., server side 153). As such, there is additional computational efficiency introduced using such as split media analytics pipeline, in which the input data 155 passes through the first backbone 160 and is compressed and transmitted (e.g., using the compression and transmission system 165) on the client side 152, followed by transmission to the edge server on the server side 153 to the second backbone 168 and subsequent execution of the first and second tasks 170, 175, etc. In the example of FIG. 1B, the first backbone 160 represents the underlying framework that supports the learning process and enables the network to extract meaningful features from the input data 155.

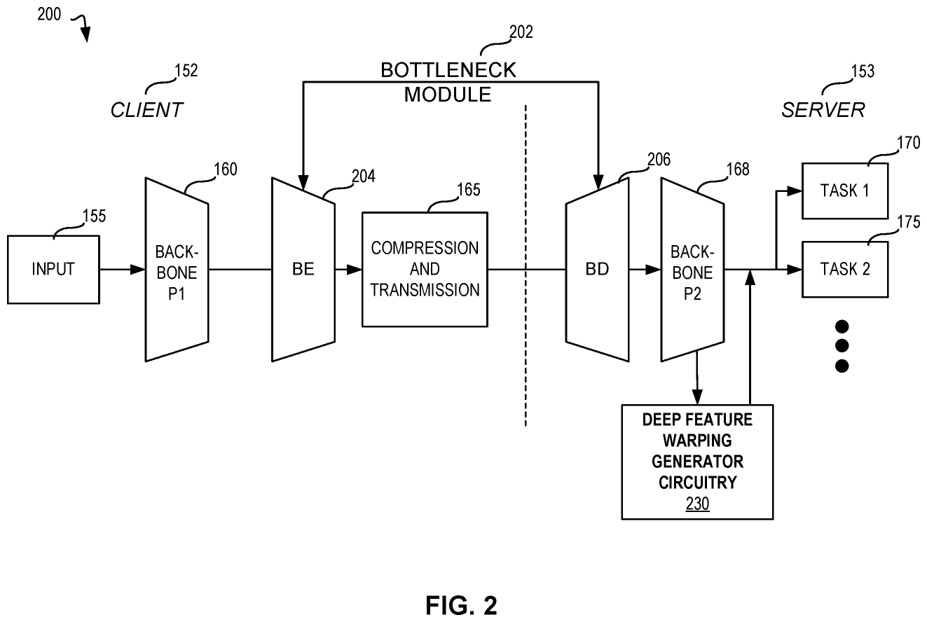

FIG. 2 illustrates an example distributed media pipeline 200 with a bottleneck module in combination with an example feature warping generator circuitry used for media analytics in accordance with teachings disclosed herein. As described in connection with FIG. 1i, the analytics computation is partitioned between the client side 152 and the server side 153, such that the computational load on the edge-server is reduced and the stream density at the edge-server increases proportionally. In the example of FIG. 2, a bottleneck module 202 is introduced to reduce the volume of data that needs to be transmitted. The bottleneck module 202 includes an example bottleneck encoder (BE) 204 and an example bottleneck decoder (BD) 206. The presence of the bottleneck module 202 permits the reduction of feature dimensions to be compressed and transmitted (e.g., using the compression and transmission system 165 of FIG. 1). For example, while the bottleneck encoder (BE) 204 transforms high-dimensional intermediate feature tensor(s) into an appropriate lower dimensional space, the bottleneck decoder (BD) 206 restores the compressed lower-dimensional tensor(s) to original dimension(s). Furthermore, in the example of FIG. 2, a split backbone is shown with the backbone network split into two parts corresponding the first backbone 160 and the second backbone 168. The first backbone 160 is positioned to process input data 155 on the client side 152, which subsequently is passed to the bottleneck encoder (BE) 204 and the second backbone 168 is positioned to process data output from the bottleneck decoder (BD) 206 on the server side 153. Data from the second backbone 168 proceeds to the first and second tasks 170, 175, etc. In examples disclosed herein, a backbone network (e.g., ResNet-50) can be split such that a first part of the network is included in the first backbone 160 and a second part of the network is included in the second backbone 168. In some examples, the ResNet-50 backbone network creates a deep feature representation tensor, and the deep feature representation tensor is further processed by a task-specific tail network.

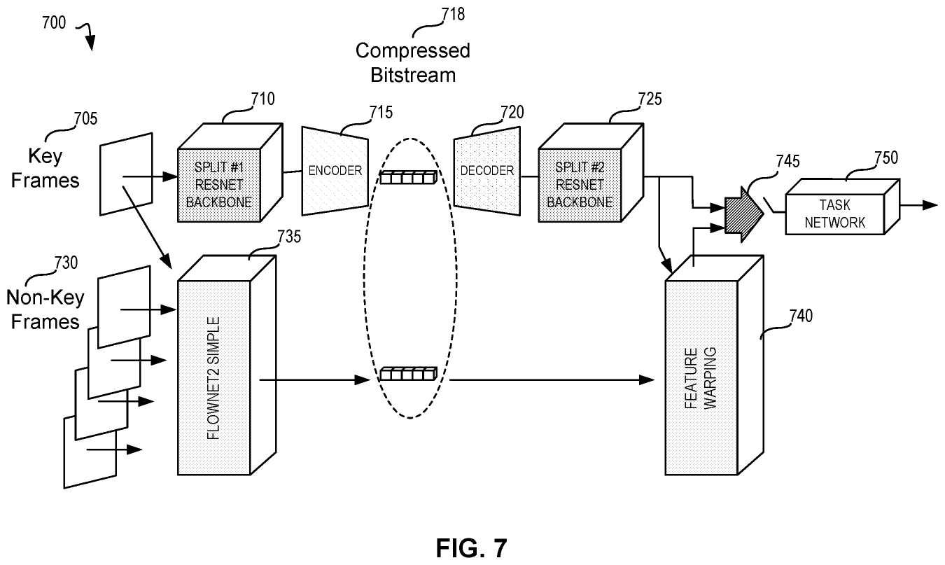

In some examples, video features can be extracted over several key frames of an entire video to reduce the computational burden associated with video frame extraction and processing. In examples disclosed herein, both key frames and non-key frames can be identified during video processing. In some examples, key frames and all other frames (e.g., frames located between the key frames) can initially be identified as non-key frames. In the example of FIG. 2, the deep feature warping generator circuitry 230 processes non-key frames in the video sequence. For example, the feature warping generator circuitry 230 computes motion displacement estimates between a current frame and the most recent key frame and uses the motion displacement estimates in an end-to-end trained pipeline to warp the deep feature representations generated in the key frames. In some examples, the feature warping generator circuitry 230 generates deep feature representations for the non-key frames in a low complexity manner while compressing the motion information and sending the compressed motion information to the decoder. For example, the motion information can be much smaller in size than the compressed key frame features, allowing for enhanced computational and compression efficiency to be obtained as compared with frame-by-frame compression and conventional video compression methods (e.g., such as H264, HEVC). In examples disclosed herein, the feature warping generator circuitry 230 applies deep feature warping in a split computing scenario with the addition of compression to the motion or flow information prior to transmission from the client side 152 to the edge server side 153 for non-key frame features, in addition to the compressed bottleneck encoder outputs for key frame features. In examples disclosed herein, the feature warping generator circuitry 230 includes adding a parameter (e.g., a key-frame interval) to the set of parameters (e.g., DNN split point, bottleneck module parameters, etc.) available for optimizing the rate-accuracy-complexity tradeoffs. As shown in more detail in connection with FIG. 7, in some examples, motion information is extracted on the client side 152 from the key frame image and the “current” (e.g., non-key frame) image. On the server side 153, features from the last keyframe and motion information from the current frame are used as inputs to the feature warping generator circuitry 230, which produces features corresponding to the current frame by “warping” the keyframe features.

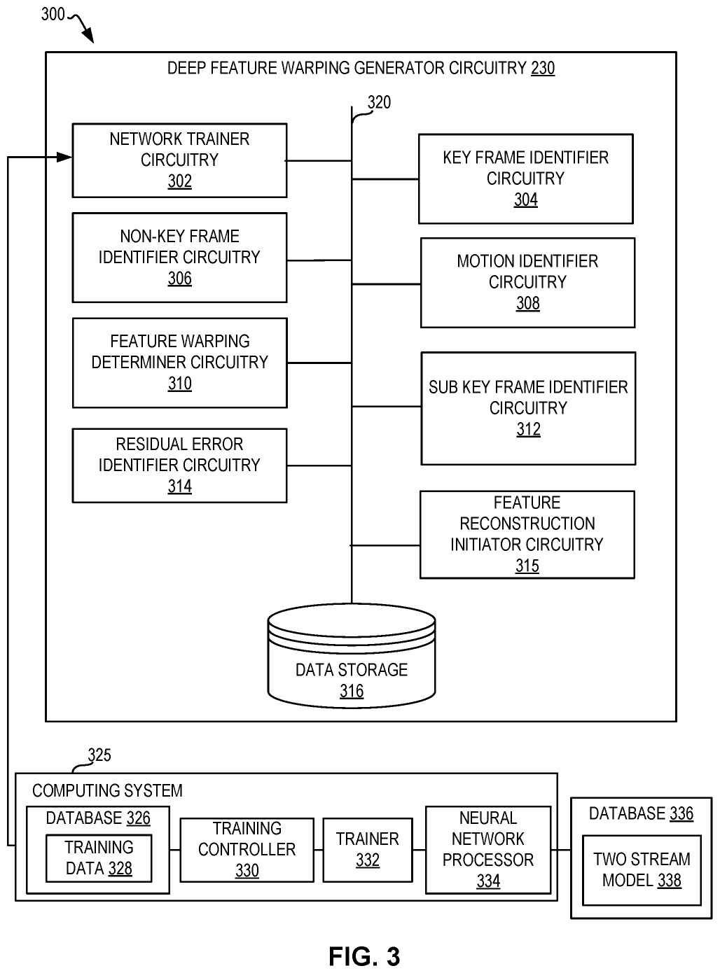

FIG. 3 is a block diagram of an example implementation of the feature warping generator circuitry 230 of FIG. 2. The feature warping generator circuitry 230 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the feature warping generator circuitry 230 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the example of FIG. 3, the feature warping generator circuitry 230 of FIG. 2 includes example network trainer circuitry 302, example key frame identifier circuitry 304, example non-key frame identifier circuitry 306, example motion identifier circuitry 308, example feature warping determiner circuitry 310, example sub key frame identifier circuitry 312, example residual error identifier circuitry 314, example feature reconstruction initiator circuitry 315, and example data storage 316. The network trainer circuitry 302, the key frame identifier circuitry 304, the non-key frame identifier circuitry 306, the motion identifier circuitry 308, the feature warping determiner circuitry 310, the sub key frame identifier circuitry 312, the residual error identifier circuitry 314, the feature reconstruction initiator circuitry 315, and the data storage 316 are in communication using an example bus 320.

In the illustrated example, the network trainer circuitry 302 trains a model (e.g., a two-stream model). In some examples, the network trainer circuitry 302 trains a deep neural network (DNN) model for tasks such as object classification, detection, segmentation, etc. In some examples, the DNN includes a backbone network (e.g., such as ResNet-50) which creates a deep feature representation tensor and is further processed by a task specific tail network. In examples disclosed herein, the network is split at a selected point based on a target edge server stream density or client-side complexity constraints, as shown in more detail in connection with FIG. 7. In some examples, the network trainer circuitry 302 trains the network (e.g., as shown in FIG. 7) end-to-end with weight updates throughout the network. In some examples, the network trainer circuitry 302 trains the entire network end-to-end but uses weights from a pre-trained backbone and/or pretrained flow generation network. For example, the network trainer circuitry 302 can start with a pretrained baseline model trained on a dataset of interest (e.g., the baseline model can include a backbone and task networks without the split shown in FIG. 7). Subsequently, the network trainer circuitry 302 trains a two-stream model including a flow generation network and feature warping operations (e.g., without any compression included in key frame or non-key frame branches). In some examples, the network trainer circuitry 302 trains the two-stream model in an end-to-end manner with task-specific loss terms. In examples disclosed herein, the network trainer circuitry 302 inserts compression models (e.g., an encoder and a decoder) into a key frame pipeline along with compression for the flow branch in the non-key frame pipeline. In some examples, the network trainer circuitry 302 trains the bottleneck modules with a combination of rate loss and end-to-end loss.

As illustrated in FIG. 3, the network trainer circuitry 302 is in communication with a computing system 325 that trains a neural network. In examples disclosed herein, the network trainer circuitry 302 splits the DNN backbone neural network at a given layer that is determined by edge/client computational complexity and/or edge stream density targets. In some examples, a set of bottleneck modules is designed to yield a rate-distortion optimized performance characteristic as part of an inference phase that follows the neural network training phase, as described in more detail below in connection with the neural network training process. Furthermore, in some examples, the network trainer circuitry 302 applies a set of compression bottleneck modules for key frame features. Bottleneck module(s) reduce the feature dimensions to be compressed and transmitted by incorporating a layer with fewer neurons than the layer above the bottleneck module or below the bottleneck module, encouraging the network to compress feature representations.

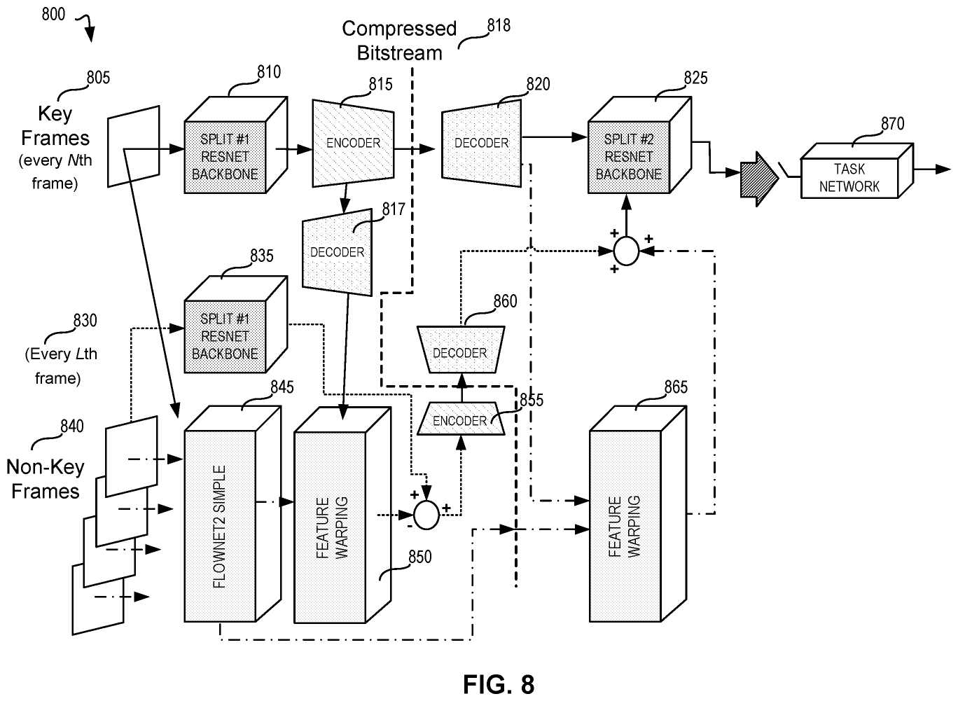

In some examples, the training process includes selecting a given set of (e.g., highest accuracy) key frame compression settings and treating other non-key frames as sub-key frames (e.g., with the compression of the key frame features in place). In some examples, computing flow-warped deep features and subtracting the warped features from the initial computed deep key frame features to yield the feature residual error can be incorporated into the network training process, as described in more detail in connection with FIG. 8. For example, the network trainer circuitry 302 can apply a lightweight bottleneck encoder-decoder module along with quantization and entropy coding to compress the feature warping residual errors. In some examples, the network trainer circuitry 302 trains these bottleneck encoder-decoder neural networks using a combination of rate and cross-entropy loss. In some examples, optimal settings for the bottleneck module parameters and quantization factors for the residual error compression can be derived using Bayesian optimization guided search, yielding a set of different operating points in terms of sub-key frame compression-accuracy tradeoffs.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, deep neural network models are used. In general, machine learning models/architectures that are suitable to use in the example approaches disclosed herein will be based on supervised learning. However, other types of machine learning models could additionally or alternatively be used such as, for example, semi-supervised learning.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, any training algorithm may be used. In examples disclosed herein, training can be performed based on early stopping principles in which training continues until the model(s) stop improving. In examples disclosed herein, training can be performed remotely or locally. In some examples, training may initially be performed remotely. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) are used. Such hyperparameters are selected by, for example, random searching and/or prior knowledge. In some examples re-training may be performed. Such re-training may be performed in response to new input datasets, drift in the model performance, and/or updates to model criteria and system specifications.

Once training is complete, the two-stream model(s) are stored in one or more databases (e.g., database 326 of FIG. 3). Once trained, the deployed model(s) may be operated in an inference phase to process data. In the inference phase, data to be analyzed (e.g., live data) is input to the model, and the model executes to create an output. This inference phase can be thought of as the A “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 3, the network trainer circuitry uses the computing system 325 to train a neural network to generate a two-stream model 338. However, any other type of neural network can be used. The example computing system 325 includes a neural network processor 334. In examples disclosed herein, the neural network processor 334 implements a neural network. The computing system 325 of FIG. 3 also includes a neural network trainer 332. The neural network trainer 332 of FIG. 3 performs training of the neural network implemented by the neural network processor 334.

The computing system 325 of FIG. 3 includes a training controller 330. The training controller 330 instructs the neural network trainer 332 to perform training of the neural network based on training data 328. In the example of FIG. 3, the training data 328 used by the neural network trainer 332 to train the neural network is stored in a database 326. The example database 326 of the illustrated example of FIG. 3 is implemented by any memory, storage device and/or storage disc for storing data such as, for example, flash memory, magnetic media, optical media, etc. Furthermore, the data stored in the example database 326 may be in any data format such as, for example, binary data, comma delimited data, tab delimited data, structured query language (SQL) structures, image data, etc. While the illustrated example database 326 is illustrated as a single element, the database 326 and/or any other data storage elements described herein may be implemented by any number and/or type(s) of memories. The neural network trainer 332 trains the neural network implemented by the neural network processor 334 using the training data 328 to generate the two-stream model 338 as a result of the neural network training. The two-stream model 338 is stored in a database 336. The databases 326, 336 may be the same storage device or different storage devices.

The key frame identifier circuitry 304 selects the first frame (C₁) from an input video sequence (e.g., input data 155 of FIGS. 1B and/or 2) as a key frame. The key frame identifier circuitry 304 processes the first frame with the entire DNN model described in connection with the network trainer circuitry 302 and shown in more detail in connection with FIGS. 7 and 8 (e.g., head network, bottleneck encoder, compression at the client, decompression with bottleneck decoder, tail network at the edge server). As described in more detail below, the output of the DNN network is the task-specific result for the key frame (e.g., classification, object bounding box localization, segmentation, etc.). In some examples, the key frame identifier circuitry 304 identifies a total head network computational complexity (M_h) for the key frame on the client-side (e.g., client side 152 of FIG. 1) and the tail network computational complexity (M_t) for the key frame on the edge server side (e.g., server side 153 of FIG. 1).

The non-key frame identifier circuitry 306 identifies non-key frames from the input video sequence (e.g., input data 155 of FIGS. 1B and/or 2). In some examples, the non-key frame identifier circuitry 306 stores the decompressed deep feature representation (S\hat{ }_1) (e.g., associated with the key frames) at the edge server (e.g., for processing the non-key frames). The non-key frame identifier circuitry 306 identifies L consecutive video frames that are non-key frames (e.g., following identification of the first key frame by the key frame identifier circuitry 304). For example, the non-key frame identifier circuitry 306 identifies a non-key frame (C_l) from the set of L consecutive video frames. Once the non-key frame is identified (e.g., a frame that is not a key frame), processing of the non-key frames occurs for the L frames before the key frame identifier circuitry 304 proceeds to identify a new key frame (e.g., a second key frame different from the first key frame).

The motion identifier circuitry 308 determines motion information, displacement, and/or optical flow (Fₗ) between the identified key-frame (e.g., key frame C₁) and the identified non-key frame (Cₗ). In some examples, the motion identifier circuitry 308 estimates optical flow using a DNN model (e.g., FlowNet-Simple, etc.) which incurs a computational complexity (M_{OF}) to calculate optical flow at the desired spatial resolution (e.g., H/16×W/16, where the input image is defined by a height (H) and a width (W)). However, any other type of algorithm can be used by the motion identifier circuitry 308 to estimate the motion information (e.g., learning-based algorithms, model-based algorithms, etc.). In some examples, the motion identifier circuitry 308 compresses the motion information to an average size of N_{OF} bits per non-key frame and transmits the information from the client (e.g., client 152) to the edge server (e.g., server 153). As such, the compressed flow size is much smaller than the compressed key frame feature size (e.g., given that N_{OF}<<N₁). In some examples, the motion identifier circuitry 308 treats the sequence of optical flow estimates as a sequence of images and compresses the images using an encoder (e.g., a High Efficiency Video Coding (HEVC) video compression codec, etc.) that best accounts for the high degree of correlation between optical flow for successive frames.

The feature warping determiner circuitry 310 estimates deep frame feature representations based on motion information identified using the motion identifier circuitry 308. In some examples, the feature warping determiner circuitry 310 determines a decompressed deep feature representation (Ŝ₁) for the key frame. In some examples, the decompressed deep feature representation at the output of the bottleneck decoder network is a lossy reconstruction of Ŝ₁, the true deep features obtained in the absence of the bottleneck module and compression. In some examples, the feature warping determiner circuitry 310 uses the decompressed deep feature representation for processing with the tail network to yield the key frame analytics results. For example, at the edge server 153 the motion information for the current non-key frame (F\hat{ }_l) is reconstructed from the lossy compressed flow received from the client 152. The feature warping determiner circuitry 310 identifies the reconstructed motion information (F\hat{ }_l) and the stored key frame deep frame features (Ŝ₁) to estimate the deep frame feature representation (Ŝₗ) for the non-key frame (Cₗ) using feature warping. In some examples, the feature warping determiner circuitry 310 uses bilinear interpolation as the feature warping function, with the motion information (\hat{F}ₗ) used in the interpolation kernel to reconstruct the deep frame feature representation (Ŝ₁), as shown below in accordance with Equation 1:

Ŝₗ(p)=Σ_{q}G(q,p+\hat{F}ₗ(p))S₁(q) Equation 1

In the example of Equation 1, q ranges over the spatial locations in the feature maps, G (., .) represents the bilinear interpolation kernel, and \hat{F}ₗ (p) represents the estimated motion (or optical flow) at location p. In some examples, the feature warping determiner circuitry 310 determines average bits per compressed frame (N_{avg}) over 1 key frame and L non-key frames, as shown below in connection with Equation 2:

$${N}_{a v g} = \frac{1}{( L + 1 ) ( {N}_{1} + L * {N}_{O F} )} \qquad Equation 2$$

In some examples, the feature warping determiner circuitry 310 determines the average computational complexity (M_{avg}) at the client side 152 in accordance with Equation 3:

$${M}_{a v g} = \frac{1}{( L + 1 ) ( {M}_{h} + L * {M}_{O F} )} \qquad Equation 3$$

In some examples, the feature warping determiner circuitry 310 reduces the computational complexity at the edge server 153 by a factor of alpha (α), as shown below in connection with Equation 4:

$$α = \frac{{M}_{t}}{{M}_{h} + {M}_{t}} \qquad Equation 4$$

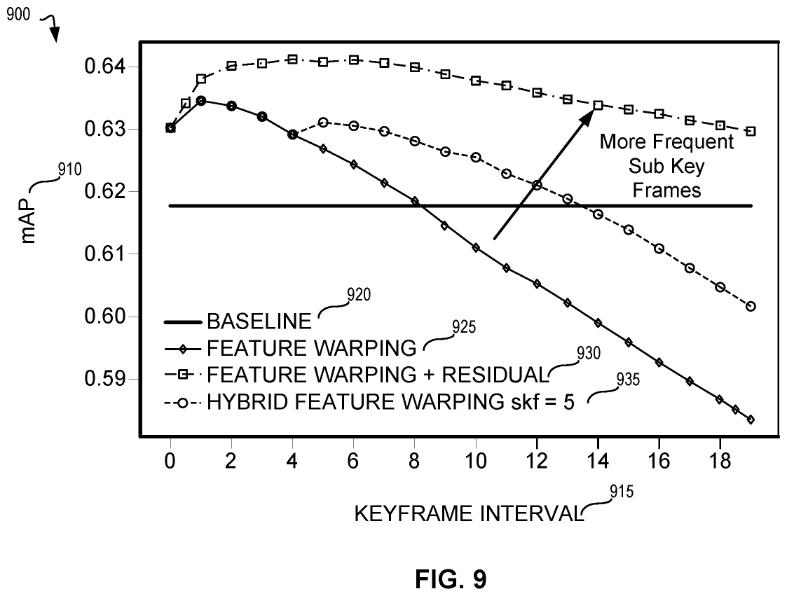

The sub-key frame identifier circuitry 312 determines the sub-key frames after the L non-key frames are assessed using the feature warping determiner circuitry 310. The sub-key frames represent selected non-key frames (e.g., at the client side) for which a residual error is computed between the warped deep features and the initial computed head network features. In examples disclosed herein, key frames are selected periodically (e.g., over a fixed period of ten frames, etc.), but the selection can also be dynamic (e.g., based on specific content such as an upcoming scene change, etc.). Frames positioned between key frames are either non-key frames or sub-key frames. In examples disclosed herein, sub-key frame features are computed using warping and a residual is used to correct the frame features on the client side. In addition, the non-key frames that follow a sub-key frame perceive the sub-key frame as a key frame, such that motion information is calculated between the current frame and sub-key frame and warping is performed using the sub-key frame features. For example, the sub-key frame features that were themselves obtained by warping with residual computation are also warped. In examples disclosed herein, the sub-key frame identifier circuitry 312 identifies the sub-key frame at frame L+1 (e.g., following a set of L non-key frames). In some examples, if a pre-determined number (K) of sub-key frames have been inserted, then a key frame is inserted instead (e.g., using the key frame identifier circuitry 304). For example, as described in more detail in connection with the residual error identifier circuitry 314, error residuals are computed periodically between the warped deep features and the initial features computed for that frame. These periodic frames are represented by the sub-key frames identified using the sub-key frame identifier circuitry 312. In some examples, the sub-key frame identifier circuitry 312 identifies every non-key frame as a sub-key frame for the computation of the flow-warped deep features, such that subtracting the warped features from the initial computed deep features yields the feature residual error, as determined using the residual error identifier circuitry 314. In examples disclosed herein, the compute load on the client side can demonstrate a larger peak-to-average ratio as key frames or sub-key frames (e.g., frames with higher complexity) are processed versus when non-key frames (e.g., frames with lower complexity) are processed, as shown in connection with FIGS. 9-12.

The residual error identifier circuitry 314 determines the feature warping residual error. For example, the warped features Ŝ_{L+1}(p) are reconstructed at the client 152, replicating the processing at the edge server 153. Subsequently, the residual error identifier circuitry 314 determines the feature warping residual error in accordance with Equation 5:

e_{L+1}(p)=S_{L+1}(p)−Ŝ_{L+1}(p) Equation 5

In some examples, the feature warping residual error is processed with a bottleneck encoder and quantization, followed by compression (e.g., using the network trainer circuitry 302). In some examples, the flow is also compressed for all the non-key frames. The residual error identifier circuitry 314 transmits the combined compressed flow and compressed feature residual errors to the edge server 153.

The feature reconstruction initiator circuitry 315 reconstructs the deep feature representation for a given frame at the edge server (e.g., edge server 153). For example, the feature reconstruction initiator circuitry 315 uses the sub-key frame, the reconstructed flow (\hat{F}_{L+1}), and the reconstructed residual error (ê_{L+1}) to reconstruct the deep feature representation (S\hat{ }_(L+1)) for the sub-key frame. Due to the addition of the residual error identified using the residual error identifier circuitry 314, the sub-key frame features are a more accurate reconstruction of the true deep features, while offering better compression efficiency than the key frame deep features. After the feature reconstruction initiator circuitry 315 completes the sub-key frame processing, the non-key frame identifier circuitry 306 identifies more non-key frames generated by the client 153, allowing the process to repeat until all key frames and non-key frames of the input video sequence are processed.

The data storage 316 can be used to store any information associated with the network trainer circuitry 302, key frame identifier circuitry 304, non-key frame identifier circuitry 306, motion identifier circuitry 308, feature warping determiner circuitry 310, sub key frame identifier circuitry 312, residual error identifier circuitry 314, and feature reconstruction initiator circuitry 315. The example data storage 316 of the illustrated example of FIG. 3 can be implemented by any memory, storage device and/or storage disc for storing data such as flash memory, magnetic media, optical media, etc. Furthermore, the data stored in the example data storage 316 can be in any data format such as binary data, comma delimited data, tab delimited data, structured query language (SQL) structures, image data, etc.

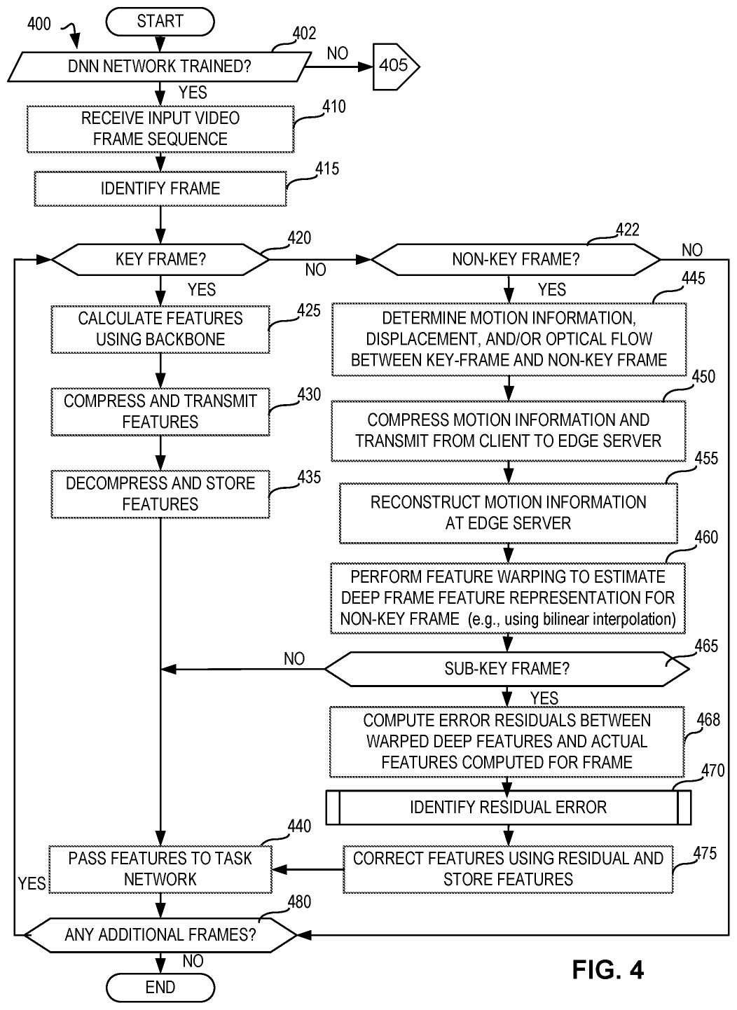

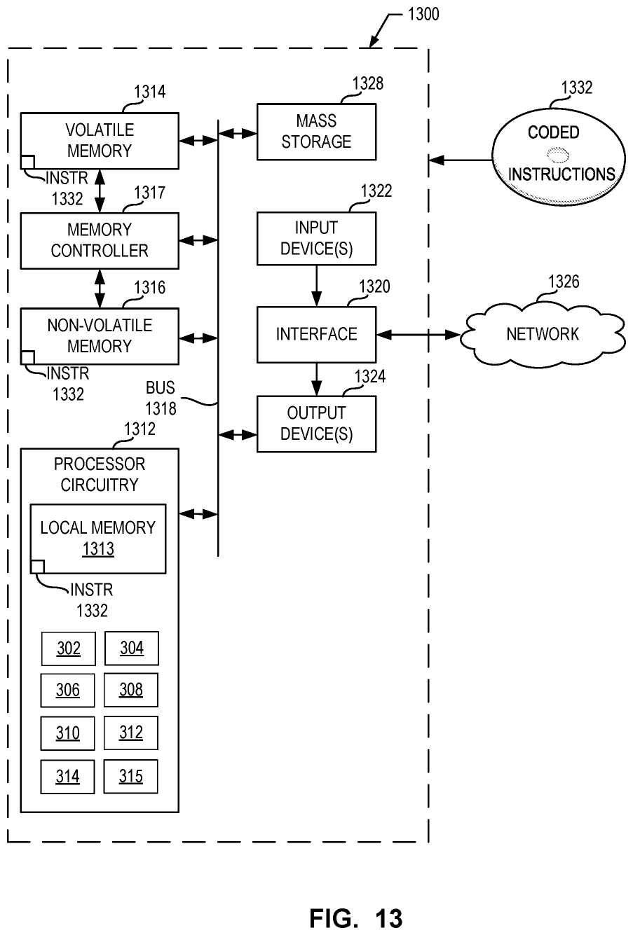

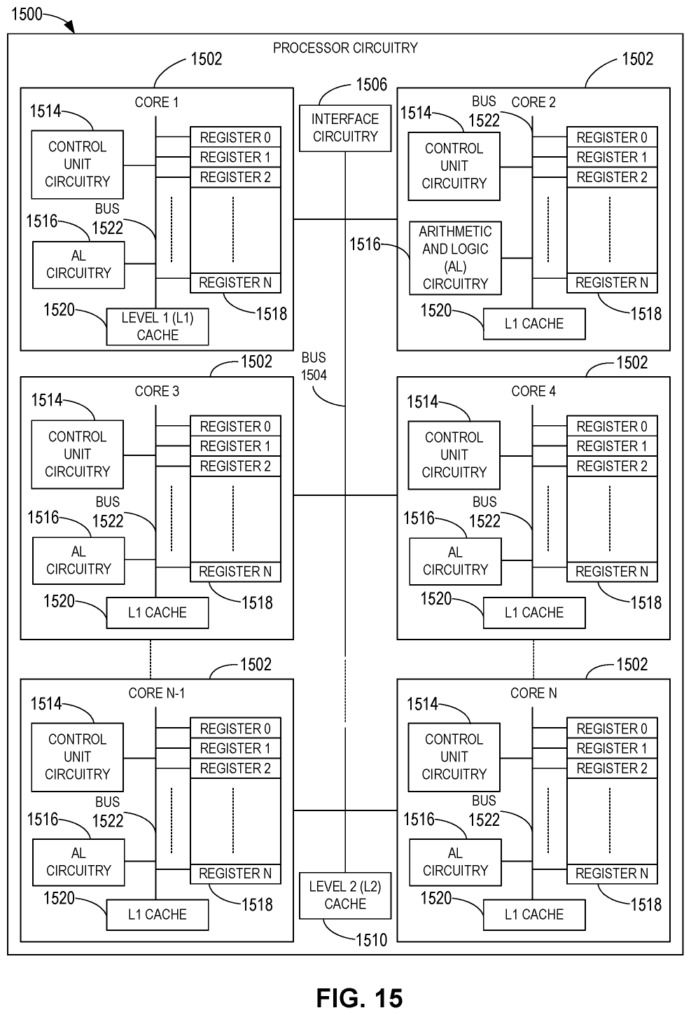

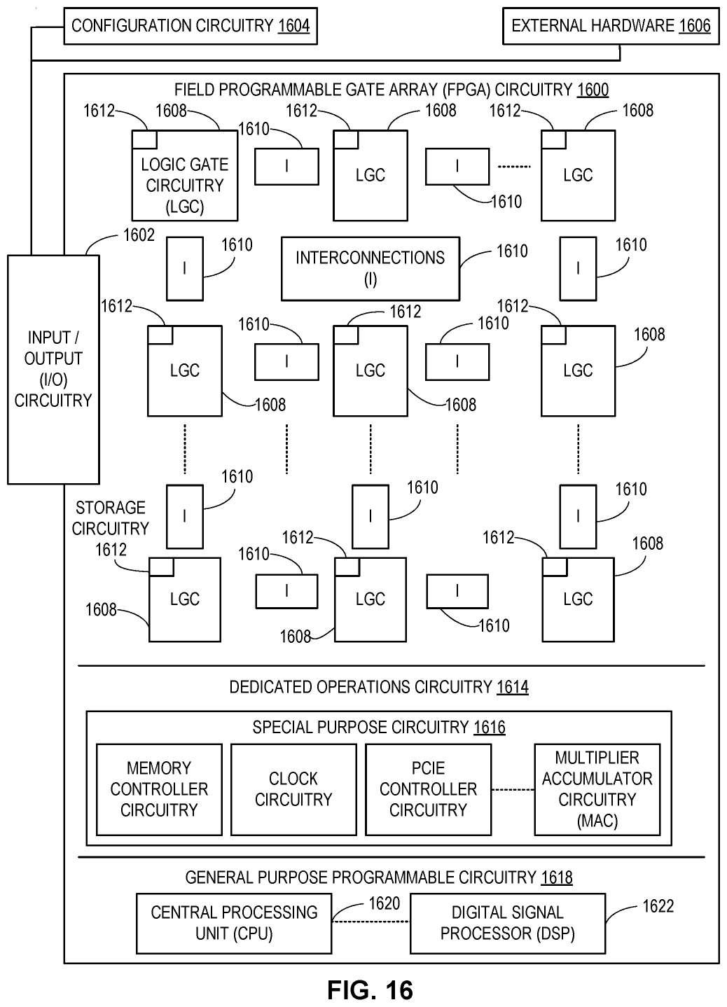

In some examples, the apparatus includes means for training a network. For example, the means for training a network may be implemented by network trainer circuitry 302. In some examples, the network trainer circuitry 302 may be instantiated by programmable circuitry such as the example programmable circuitry 1312 of FIG. 13. For instance, the network trainer circuitry 302 may be instantiated by the example microprocessor 1500 of FIG. 15 executing machine executable instructions such as those implemented by at least block 402 of FIG. 4. In some examples, the network trainer circuitry 302 may be instantiated by hardware logic circuitry, which may be implemented by an ASIC, XPU, or the FPGA circuitry 1600 of FIG. 16 structured to perform operations corresponding to the machine readable instructions. Additionally or alternatively, the network trainer circuitry 302 may be instantiated by any other combination of hardware, software, and/or firmware. For example, the network trainer circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a key frame. For example, the means for identifying a key frame may be implemented by the key frame identifier circuitry 304. In some examples, the key frame identifier circuitry 304 may be instantiated by programmable circuitry such as the example programmable circuitry 1312 of FIG. 13. For instance, the key frame identifier circuitry 304 may be instantiated by the example microprocessor 1500 of FIG. 15 executing machine executable instructions such as those implemented by at least block 415 of FIG. 4. In some examples, the key frame identifier circuitry 304 may be instantiated by hardware logic circuitry, which may be implemented by an ASIC, XPU, or the FPGA circuitry 1600 of FIG. 16 structured to perform operations corresponding to the machine readable instructions. Additionally or alternatively, the key frame identifier circuitry 304 may be instantiated by any other combination of hardware, software, and/or firmware. For example, the key frame identifier circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a non-key frame. For example, the means for identifying a non-key frame may be implemented by the non-key frame identifier circuitry 306. In some examples, the non-key frame identifier circuitry 306 may be instantiated by programmable circuitry such as the example programmable circuitry 1312 of FIG. 13. For instance, the non-key frame identifier circuitry 306 may be instantiated by the example microprocessor 1500 of FIG. 15 executing machine executable instructions such as those implemented by at least block 420 of FIG. 4. In some examples, the non-key frame identifier circuitry 306 may be instantiated by hardware logic circuitry, which may be implemented by an ASIC, XPU, or the FPGA circuitry 1600 of FIG. 16 structured to perform operations corresponding to the machine readable instructions. Additionally or alternatively, the non-key frame identifier circuitry 306 may be instantiated by any other combination of hardware, software, and/or firmware. For example, the non-key frame identifier circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying motion. For example, the means for identifying motion may be implemented by the motion identifier circuitry 308. In some examples, the motion identifier circuitry 308 may be instantiated by programmable circuitry such as the example programmable circuitry 1312 of FIG. 13. For instance, the motion identifier circuitry 308 may be instantiated by the example microprocessor 1500 of FIG. 15 executing machine executable instructions such as those implemented by at least block 425 of FIG. 4. In some examples, the motion identifier circuitry 308 may be instantiated by hardware logic circuitry, which may be implemented by an ASIC, XPU, or the FPGA circuitry 1600 of FIG. 16 structured to perform operations corresponding to the machine readable instructions. Additionally or alternatively, the motion identifier circuitry 308 may be instantiated by any other combination of hardware, software, and/or firmware. For example, the motion identifier circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for warping features. For example, the means for warping features may be implemented by the feature warping determiner circuitry 31. In some examples, the feature warping determiner circuitry 310 may be instantiated by programmable circuitry such as the example programmable circuitry 1312 of FIG. 13. For instance, the feature warping determiner circuitry 310 may be instantiated by the example microprocessor 1500 of FIG. 15 executing machine executable instructions such as those implemented by at least block 440 of FIG. 4. In some examples, the feature warping determiner circuitry 310 may be instantiated by hardware logic circuitry, which may be implemented by an ASIC, XPU, or the FPGA circuitry 1600 of FIG. 16 structured to perform operations corresponding to the machine readable instructions. Additionally or alternatively, the feature warping determiner circuitry 310 may be instantiated by any other combination of hardware, software, and/or firmware. For example, the feature warping determiner circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

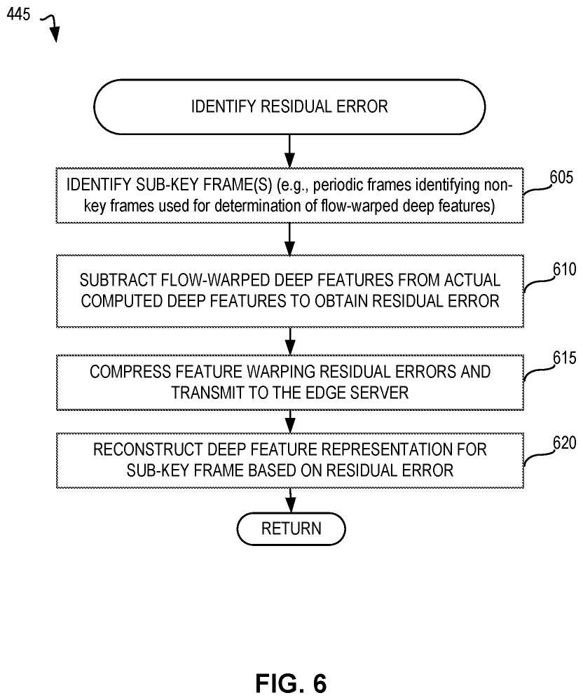

In some examples, the apparatus includes means for identifying a sub key frame. For example, the means for identifying a sub key frame may be implemented by the sub key frame identifier circuitry 312. In some examples, the sub key frame identifier circuitry 312 may be instantiated by programmable circuitry such as the example programmable circuitry 1312 of FIG. 13. For instance, the sub key frame identifier circuitry 312 may be instantiated by the example microprocessor 1500 of FIG. 15 executing machine executable instructions such as those implemented by at least block 605 of FIG. 6. In some examples, the sub key frame identifier circuitry 312 may be instantiated by hardware logic circuitry, which may be implemented by an ASIC, XPU, or the FPGA circuitry 1600 of FIG. 16 structured to perform operations corresponding to the machine readable instructions. Additionally or alternatively, the sub key frame identifier circuitry 312 may be instantiated by any other combination of hardware, software, and/or firmware. For example, the sub key frame identifier circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a residual error. For example, the means for identifying a residual error may be implemented by the residual error identifier circuitry 314. In some examples, the residual error identifier circuitry 314 may be instantiated by programmable circuitry such as the example programmable circuitry 1312 of FIG. 13. For instance, the residual error identifier circuitry 314 may be instantiated by the example microprocessor 1500 of FIG. 15 executing machine executable instructions such as those implemented by at least block 610 of FIG. 6. In some examples, the residual error identifier circuitry 314 may be instantiated by hardware logic circuitry, which may be implemented by an ASIC, XPU, or the FPGA circuitry 1600 of FIG. 16 structured to perform operations corresponding to the machine readable instructions. Additionally or alternatively, the residual error identifier circuitry 314 may be instantiated by any other combination of hardware, software, and/or firmware. For example, the residual error identifier circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for initiating feature reconstruction. For example, the means for initiating feature reconstruction may be implemented by the feature reconstruction initiator circuitry 315. In some examples, the feature reconstruction initiator circuitry 315 may be instantiated by programmable circuitry such as the example programmable circuitry 1312 of FIG. 13. For instance, the feature reconstruction initiator circuitry 315 may be instantiated by the example microprocessor 1500 of FIG. 15 executing machine executable instructions such as those implemented by at least block 620 of FIG. 6. In some examples, the feature reconstruction initiator circuitry 315 may be instantiated by hardware logic circuitry, which may be implemented by an ASIC, XPU, or the FPGA circuitry 1600 of FIG. 16 structured to perform operations corresponding to the machine readable instructions. Additionally or alternatively, the feature reconstruction initiator circuitry 315 may be instantiated by any other combination of hardware, software, and/or firmware. For example, the feature reconstruction initiator circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing deep feature warping generator circuitry 230 of FIG. 2 is illustrated in FIG. 3, one or more of the elements, processes and/or devices illustrated in FIG. 3 may be combined, divided, re-arranged, omitted, eliminated and/or implemented in any other way. Further, the example network trainer circuitry 302, key frame identifier circuitry 304, non-key frame identifier circuitry 306, motion identifier circuitry 308, feature warping determiner circuitry 310, sub key frame identifier circuitry 312, residual error identifier circuitry 314, feature reconstruction initiator circuitry 315, and/or, more generally, the example deep feature warping generator circuitry 230 of FIG. 2 may be implemented by hardware, software, firmware and/or any combination of hardware, software and/or firmware. Thus, for example, any of the example network trainer circuitry 302, key frame identifier circuitry 304, non-key frame identifier circuitry 306, motion identifier circuitry 308, feature warping determiner circuitry 310, sub key frame identifier circuitry 312, residual error identifier circuitry 314, feature reconstruction initiator circuitry 315, and/or, more generally, the example deep feature warping generator circuitry 230 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the deep feature warping generator circuitry 230 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the deep feature warping generator circuitry 230 of FIG. 2 and/or representative of example operations which may be performed by programmable circuitry to implement and/or instantiate the deep feature warping generator circuitry 230 of FIG. 2, are shown in FIGS. 4-6. The machine readable instructions may be one or more executable programs or portion(s) of one or more executable programs for execution by programmable circuitry, such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 4-6, many other methods of implementing the example deep feature warping generator circuitry 230 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

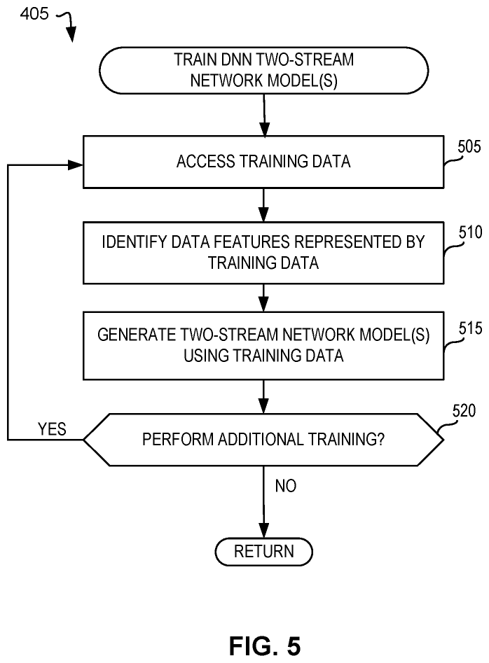

FIG. 4 is a flowchart representative of example machine readable instructions and/or example operations 400 that may be executed, instantiated, and/or performed by programmable circuitry to implement the example deep feature warping generator circuitry of FIG. 3. The machine readable instructions and/or the operations 400 of FIG. 4 begin at block 402, at which the network trainer circuitry 302 determines whether the deep neural network (DNN) is trained. If the network trainer circuitry 302 determines that the neural network is not trained, control proceeds to block 405 to initiate the training in accordance with the instructions of FIG. 5. For example, the network trainer circuitry 302 trains a two-stream model, as shown in connection with FIG. 7. In some examples, the neural network includes a backbone network which creates a deep feature representation tensor and is further processed by a task specific tail network. As described in connection with FIG. 3, the network trainer circuitry 302 inserts compression models (e.g., an encoder and a decoder) into a key frame pipeline along with compression for the flow branch in the non-key frame pipeline. Once the network trainer circuitry 302 determines that the neural network is trained, the key frame identifier circuitry 304 receives an input video frame sequence (e.g., input data 155 of FIG. 1), at block 410. The key frame identifier circuitry 304 proceeds to identify and process the first frame associated with the received input video frame sequence, at block 415. For example, the key frame identifier circuitry 304 selects the first frame from the input video sequence. The key frame identifier circuitry 304 determines whether the selected frame is a key frame, at block 420. If the key frame identifier circuitry 304 determines that the selected frame is not a key frame, the non-key frame identifier circuitry 306 verifies that the selected frame is a non-key frame, at block 422. If the selected frame is a key frame, the frame is passed through the split network generated using the network trainer circuitry 302. In some examples, the key frame identifier circuitry 304 identifies features using the backbone network, at block 425. In some examples, the key frame identifier circuitry 304 compresses and transmits the identified features, at block 430. For example, the key frame identifier circuitry 304 transmits the compressed features from the client 152 to the server 153. In some examples, the feature reconstruction initiator circuitry 315 determines a decompressed deep feature representation for the key frame, at block 435 (e.g., where the decompressed deep feature representation at the output of the bottleneck decoder network is a lossy reconstruction of the decompressed deep feature representation). The feature reconstruction initiator circuitry 315 passes the decompressed features to the task network on the server side 153, at block 440, as described in connection with FIG. 2.

Separately, the non-key frame identifier circuitry 306 identifies non-key frame(s) from the input video sequence, at block 422. For example, the non-key frame identifier circuitry 306 identifies consecutive video frames that are non-key frames. In particular, the motion identifier circuitry 308 determines motion information, displacement, and/or optical flow between the identified key-frame and the identified non-key frame, at block 445. In some examples, the motion identifier circuitry 308 compresses the motion information and transmits the information from the client 152 to the edge server 153 to make the compressed flow size smaller than the compressed key frame feature size, at block 450. Subsequently, the feature warping determiner circuitry 310 estimates deep frame feature representations based on the motion information after reconstructing the motion information at the edge server, at block 455. For example, the feature warping determiner circuitry 310 identifies the reconstructed motion information and the stored key frame deep frame features to estimate the deep frame feature representation for the non-key frame (e.g., using bilinear interpolation, etc.), at block 460. In some examples, the feature warping determiner circuitry 310 reduces the computational complexity at the edge server by a predefined or input factor (e.g., a factor of alpha, as described in connection with FIG. 3) using feature warping. If the residual error identifier circuitry 314 determines, at block 465, that the frame is a sub-key frame, the residual error identifier circuitry 314 proceeds with computing error residuals between the warped features and initial features computed for the frame, at block 468. Once the residual error identifier circuitry 314 identifies the residual error at block 470, as described in connection with FIG. 6, the feature reconstruction initiator circuitry 315 corrects features using the identified residual error and stores the updated features, at block 475. If the residual error identifier circuitry 314 determines that residual errors are not to be determined (e.g., based on user preference, etc.), the feature reconstruction initiator circuitry 315 passes deep frame feature representations for the non-key frames to the task network on the server side 153, at block 440 If the key frame identifier circuitry 304 determines that there are additional frames to process, at block 480, control returns to block(s) 420 and/or 422 to identify key frames and/or non-key frame(s). For example, the non-key frame identifier circuitry 306, motion identifier circuitry 308, and/or feature warping determiner circuitry 310 repeat the process described above to identify additional non-key frame(s), compress motion information, and/or perform feature warping for the non-key frame(s), etc.

FIG. 5 is a flowchart representative of example machine readable instructions and/or example operations 405 that may be executed, instantiated, and/or performed by programmable circuitry to implement the example network trainer circuitry 302 of FIG. 3. The machine readable instructions and/or the operations 400 of FIG. 4 begin at block 505, at which the network trainer circuitry 302 accesses training data 328. The training data 328 can be used to create a deep feature representation tensor for processing by a task specific tail network. In examples disclosed herein, the network is split at a selected point based on a target edge server stream density or client-side complexity constraints, as shown in more detail in connection with FIG. 7. In some examples, the network can be trained using weights from a pre-trained backbone and/or pretrained flow generation network. For example, a pretrained baseline model can be trained on a dataset of interest, with the resulting two-stream model 338 including a flow generation network and feature warping operations. In some examples, the two-stream model 338 includes compression models (e.g., an encoder and a decoder) in a key frame pipeline along with compression for the flow branch in the non-key frame pipeline, as shown in connection with FIGS. 7 and/or 8. In some examples, the bottleneck modules can be trained with a combination of rate loss and end-to-end loss. The trainer 332 identifies data features represented by the training data 328, at block 510. In some examples, the training controller 330 instructs the trainer 332 to perform training of the neural network using the training data 328 to generate a two-stream model 338, at block 515. In some examples, additional training is performed to refine the two-stream model 338, at block 520.

FIG. 6 is a flowchart representative of example machine readable instructions and/or example operations 445 that may be executed, instantiated, and/or performed by programmable circuitry to implement the example deep feature warping generator circuitry 230 of FIG. 3. The machine readable instructions and/or the operations 445 of FIG. 6 begin at block 605, at which the sub-key frame identifier circuitry 312 determines the sub key frames after the non-key frame(s) are assessed using the feature warping determiner circuitry 310. For example, compute error residuals are computed periodically between the warped deep features and the initial features computed for that frame. These periodic frames are represented by the sub-key frames identified using the sub-key frame identifier circuitry 312. The sub-key frame identifier circuitry 312 identifies every non-key frame as a sub-key frame for the computation of flow-warped deep features. For example, the residual error identifier circuitry 314 subtracts the flow warped deep features from the initial computed deep features to yield the feature residual error, at block 610. Subsequently, the residual error identifier circuitry 314 transmits the combined compressed flow and compressed feature residual errors to the edge server 153, at block 615. The feature reconstruction initiator circuitry 315 reconstructs the deep feature representation for a given frame at the edge server 153, at block 620. For example, the feature reconstruction initiator circuitry 315 uses the sub-key frame, the reconstructed flow, and the reconstructed residual error to reconstruct the deep feature representation for the sub-key frame. Addition of the residual error allows the the sub-key frame features to render a more accurate reconstruction of the true deep features, with improved compression efficiency.

FIG. 7 illustrates an example first deep feature warping-based learned semantic video compression pipeline 700 with split deep neural network (DNN) compute and bottleneck modules for compressing deep features. In the example of FIG. 7, the feature warping-based learned semantic video compression pipeline 700 includes the processing of key frames 705 (e.g., from a video sequence) through a first backbone network 710 (e.g., ResNet backbone) and an encoder 715 (e.g., resulting in the compressed bitstream 718), followed by processing of the compressed bitstream 718 by a decoder 720 and a second backbone network 725. For example, the second backbone network 725 represents a second half of the backbone (e.g., the first backbone network 710 includes the first three layers of a ResNet-50 network and the second backbone network 725 includes the remaining two layers of the ResNet-50 network, etc.). In the example of FIG. 7, the non-key frame(s) 730 are processed using motion estimation and/or optical flow 735 (e.g., FlowNet2Simple optical flow), followed by feature warping 740, as described in more detail in connection with FIG. 3. Results of the processing of the key frame(s) 705 and the non-key frame(s) 730 are combined at 745 for further processing using the example task network 750. For example, during the processing of a live video, one frame at a time can be obtained, so processing of the key frame happens first, followed by processing of one or more non-key frames (e.g., one frame at a time), followed by processing of the next key frame, etc. FIG. 7 illustrates the use of split-DNN computing with lightweight bottleneck encoder-decoder networks for deep feature compression for images, applied to key frames in a video sequence and motion-driven warping of deep feature representations to generate those representations for the non-key frames from preceding key frames. As previously described, bottleneck modules can be used for efficient, low complexity variable bit rate semantic preserving compression. In typical applications where video cameras are generating a sequence of video frames, the successive frames typically have considerable correlation between the frames. Not leveraging the existing correlation and treating the frames as individual images leads to unnecessarily large AI computational complexity as well as poor compression efficiency. In methods and apparatus disclosed herein, a distributed video-analytics pipeline, as shown in FIG. 7, leverages dynamic DNN partitioning with variable bit rate compression and motion estimation/optical flow-based processing of the deep feature representations. As such, optimization of computational complexity (e.g., at the client or edge), compression efficiency, and/or task accuracy can be achieved.

FIG. 8 illustrates an example second deep feature warping-based learned semantic video compression 800 with a split DNN compute. In the example of FIG. 8, key frame(s) 805 (e.g., every N^{th} frame) are processed as described in connection with FIG. 7. For example, the key frame(s) 805 pass through the feature warping-based learned semantic video compression pipeline (e.g., includes the processing of key frames 805 through a first backbone network 810 and an encoder 815 to obtain a compressed bitstream 818, followed by processing of the compressed bitstream 818 by a decoder 820 and a second backbone network 825). In the example of FIG. 8, key frames are inserted at suitably large intervals and deep features are compressed at a reasonably high accuracy. For several succeeding non-key frames, deep feature warping and flow compression is also applied, as previously shown in connection with FIG. 7. However, in FIG. 8, for some selected non-key frames at the client side (e.g., sub-key frames), a residual error is computed between the warped deep features and the decompressed key frame features. For example, the residual error is determined between the warped features and the features obtained by passing the image through the first backbone network 810, the encoder 815, the decoder 820, and the second backbone network 825. For example, the entire key frame pipeline is performed on the client side to determine what the features would have been if the frame was treated as a key frame. This deep feature residual error is then compressed and transmitted to the edge server in addition to the compressed flow information. At the server, the residual is used to correct the warped features. By properly designing the compression for the feature residual errors, feature warping errors are corrected as they accumulate over time. The sub-key frames thus function like key frames but at a fraction of the cost in terms of data transmitted, given that the feature warping residual error is more highly compressible than the deep features themselves. In some examples, corrected features from the sub-key frame are stored in place of the features of the last key frame and used as the basis for warping subsequent non-key frames. At the client side, optical flow can be calculated between the sub-key frame and the non-key frame. In some examples, the computation cost of the sub-key frames is marginally larger than true key frames due to the flow computation added to the head network complexity. For example, in FIG. 8, every L^{th} frame 830 is selected as a sub-key frame from the non-key frame(s) 840. The sub-key frame(s) 830 undergo processing through backbone 835 and this information is combined with non-key frame(s) 840 processing information (e.g., resulting from motion estimation and/or optical flow 845 and feature warping network 850). In the example of FIG. 8, the feature warping network 850 receives decoded key frame-based information from decoder 817. The data streams are compressed by encoder 855 (e.g., as compressed bitstream 818) and received at decoder 860. The decoder 860 decodes the compressed bitstream 818, with both the decoded data stream and a data stream originating from feature warping network 865 transmitted to the second backbone network 825. In the example of FIG. 8, the feature warping network 865 directly receives the optical flow information associated with the non-key frame(s) 840 processing, as previously shown in connection with FIG. 7, in addition to receiving decoded compressed bitstream 818 information from the decoder 820. Once the second backbone network 825 receives the decoded data with associated feature warping errors, processing of the data steams is completed by task network 870.

As such, in examples disclosed herein associated with client-edge-cloud computing scenarios, the DNN compute for video analytics is optimized with greater efficiency. The DNN compute for video analytics disclosed herein enables very flexible and adaptive split-DNN computing for video sequences that can vary in bitrate, in client compute complexity, or in stream density (e.g., at the edge) in response to dynamically varying resource constraints, while optimizing performance and costs for users. This process can be generalized across a range of visual analytics DNN-based workloads and can further motivate adoption of on premise or local edge compute to complement client compute capabilities in a variety of visual edge applications. Furthermore, computational capabilities of the client platforms can be leveraged to improve compression efficiency and task accuracy. In examples disclosed herein, as the bit rate is varied, the key frame interval and the sub-key frame interval can be adjusted accordingly. In later stages, loading different lightweight bottleneck module weights can be used (e.g., given a minimal memory cost), such that adaptation to bandwidth constraints occurs in a very granular and low latency manner without any spikes in memory bandwidth usage. In some examples, congestion caused by mismatches to available network bandwidth can be avoided by adapting in a fine-grained manner to available bandwidth, as opposed to solutions which may need to reload entirely new weight sets for the DNN. In examples disclosed herein, the compute-based load on the client side can demonstrate a larger peak-to-average ratio as key frames or sub-key frames (e.g., frames with high complexity) are processed as opposed to when non-key frames (e.g., frames with low complexity) are processed.

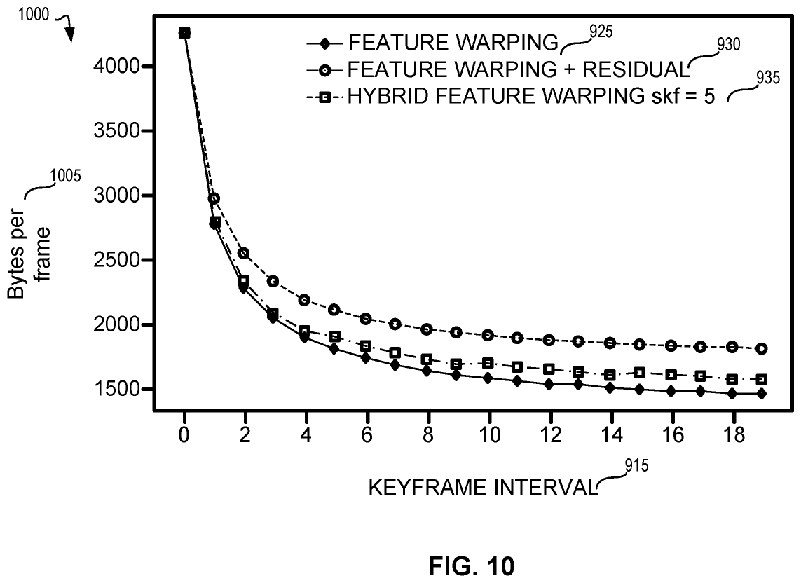

FIG. 9 illustrates example results 900 for object detection accuracy associated with key frame intervals using methods and apparatus disclosed herein. In the example of FIG. 9, results are shown based on a visual analytics task associated with object detection using a Faster-R-CNN (FRCNN) network with a ResNet-50 backbone. The models are trained on ImageNet VID and DET datasets and accuracy is calculated as the mean average precision 910 (mAP). In the example of FIG. 9, the FRCNN model is split at the end of the ResNet-50 backbone such that the total head network computational complexity (M_h) is approximately 126.76 Giga multi-accumulates (GMACs), the tail network computational complexity (Mt) is approximately 52.77 GMACs, and the FlowNet complexity (M_{OF}) is approximately 14.52 GMACs. Thus, the edge server complexity in this case is reduced by and alpha (α) of approximately 0.294, which can also be viewed as a stream density scaling of approximately 3.4 times versus a baseline case where the entire DNN model is running on the edge server. In the example of FIG. 9, variation in accuracy (e.g., mAP 910) is shown as a function of a key frame interval 915. In the example of FIG. 9, a baseline 920 is shown at an mAP of approximately 0.62. Additionally, results for feature warping 925, feature warping with compressed feature warping residual 930, and hybrid feature warping 935. For example, feature warping alone (e.g., feature warping 925) shows an mAP decrease with increasing key frame interval(s). Separately, feature warping with compressed feature warping residual 930 shows the effect of inserting sub-key frames (i.e., including compressed feature warping residuals in all the non-key frames). For example, accuracy is improved even at longer key frame separations. Furthermore, the use of hybrid feature warping 935 (e.g., inserting a sub-key frame for every 5 non-key frames) results in better performance at the expense of a small increase in compressed frame size, as shown in the example of FIG. 10.

FIG. 10 illustrates examples results 1000 for average frame size of a combination of key frames, non-key frames and sub-key frames, as a function of key frame interval. In the example of FIG. 10, bytes per frame 1005 (e.g., average compressed frame size) are shown versus the key frame interval 915. As described in connection with FIG. 9, feature warping with compressed feature warping residual 930 shows the effect of inserting sub-key frames, with accuracy improved at longer key frame separations, while the use of hybrid feature warping 935 results in better performance at the expense of a small increase in compressed frame size. Overall, the average compressed frame size increases correspondingly.

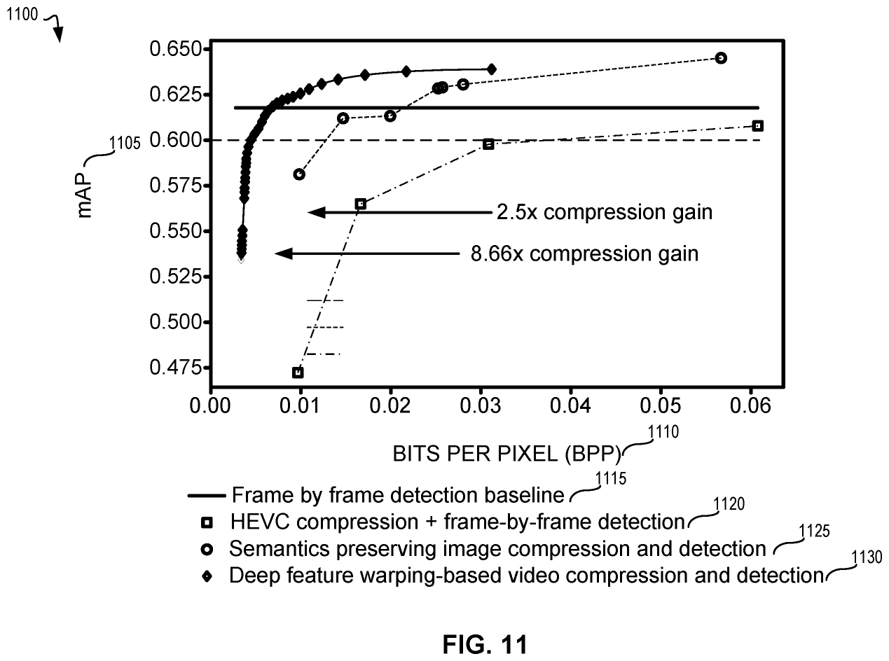

FIG. 11 illustrates example results 1100 for object detection accuracy versus compression efficiency when comparing the methods and apparatus disclosed herein to a standards-based compression. In the example of FIG. 11, variation in accuracy (e.g., mAP 1105) is shown as a function of the compression level (e.g., bits per pixel (BPP) 1110), with a frame-by-frame detection baseline 1115, HEVC-based compression with frame-by-frame detection 1120, semantics preserving image compression and detection 1125, and deep feature warping-based video compression and detection 1130. The HEVC-based compression with frame-by-frame detection 1120 results show composite performance from selecting points from a pareto optimal frontier in a search over a parameter space that includes (i) key frame compression parameters and (ii) the key frame interval. Deep feature warping-based video compression and detection 1130 results are obtained from compressing the original video sequences with HEVC encoding while using default settings in software such as FFmpeg (e.g., open-source software project for handling video, audio, and other multimedia files and streams) at different quality factors and calculating the accuracy resulting from running the baseline FRCNN model on the decoded video sequences. Methods and apparatus disclosed herein (e.g., deep feature warping-based video compression and detection 1130) achieve a gain in compression efficiency of over 8.66 times compared with the HEVC baseline.

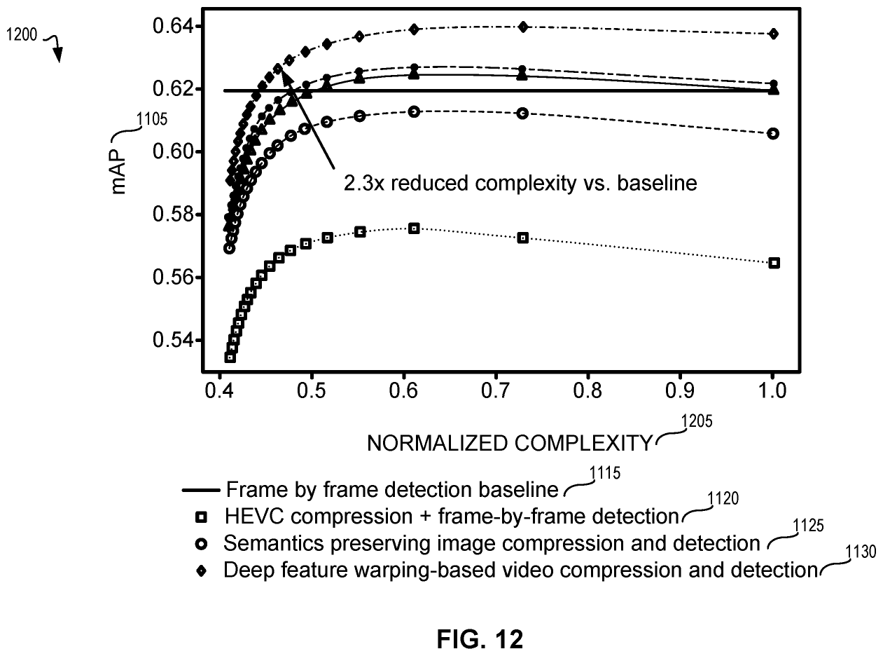

FIG. 12 illustrates example results 1200 for object detection accuracy versus average client-side computational complexity. In the example of FIG. 12, accuracy in mAP 1105 is shown versus normalized complexity 1205 (e.g., average total client-side complexity determined using Equation 2). As in the example of FIG. 11, the frame-by-frame detection baseline 1115, the HEVC-based compression with frame-by-frame detection 1120, the semantics preserving image compression and detection 1125, and the deep feature warping-based video compression and detection 1130 are compared. Methods and apparatus disclosed herein (e.g., deep feature warping-based video compression and detection 1130) achieve an average client-side complexity reduction of 0.43 times (e.g., a reduction in client complexity by 1/0.43, or approximately 2.3 times versus the baseline).

FIG. 13 is a block diagram of an example programmable circuitry platform 1300 structured to execute and/or instantiate the example machine-readable instructions and/or the example operations of FIGS. 4-6 to implement the example deep feature warping generator circuitry 230 of FIG. 3. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs microprocessors, CPUs, GPUs, DSPs, and/or microcontrollers from any desired family or manufacturer. The programmable circuitry 1312 may be implemented by one or more semiconductor based (e.g., silicon based) devices. In this example, the processor circuitry 1312 implements the network trainer circuitry 302, the key frame identifier circuitry 304, the non-key frame identifier circuitry 306, the motion identifier circuitry 308, the feature warping determiner circuitry 310, the sub key frame identifier circuitry 312, the residual error identifier circuitry 314, and the feature reconstruction initiator circuitry 315.

The programmable circuitry 1312 of the illustrated example includes a local memory 1313 (e.g., a cache, registers, etc.). The programmable circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output devices 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1300 of the illustrated example also includes one or more mass storage devices 1328 to store software and/or data. Examples of such mass storage devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1332, which may be implemented by the machine readable instructions of FIGS. 4 and/or 6, may be stored in the mass storage device 1438, in the volatile memory 1314, in the non-volatile memory 1316, and/or on at least one non-transitory computer readable storage medium such as a CD or DVD which may be removable.

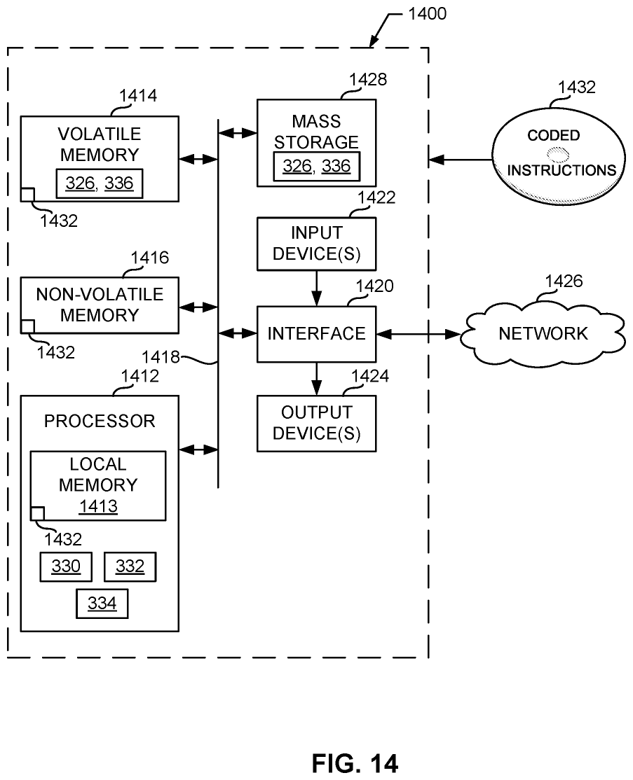

FIG. 14 is a block diagram of an example programmable circuitry platform 1400 structured to execute and/or instantiate the example machine-readable instructions and/or the example operations of FIG. 5 to implement the example computing system 325 of FIG. 3. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the example neural network processor 334, the example trainer 332, and the example training controller 330.

The programmable circuitry 1412 of the illustrated example includes a local memory 1413 (e.g., a cache, registers, etc.). The programmable circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output devices 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1400 of the illustrated example also includes one or more mass storage devices 1428 to store software and/or data. Examples of such mass storage devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1432, which may be implemented by the machine readable instructions of FIG. 5, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1312, 1412 of FIGS. 13-14. In this example, the programmable circuitry 1312, 1412 of FIGS. 13-14 is implemented by a microprocessor 1500. For example, the microprocessor 1500 may be a general purpose microprocessor (e.g., general purpose microprocessor circuitry). The microprocessor 1500 executes some or all of the machine readable instructions of the flowchart of FIGS. 4, 5 and/or 6 to effectively instantiate the circuitry of FIG. 3 logic circuits to perform the operations corresponding to those machine readable instructions. In some such examples, the circuitry of FIG. 3 is instantiated by the hardware circuits of the microprocessor 1500 in combination with the instructions. For example, the microprocessor 1500 may implement multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 4, 5 and/or 6.

The cores 1502 may communicate by a first example bus 1504. In some examples, the first bus 1504 may implement a communication bus to effectuate communication associated with one(s) of the cores 1502. For example, the first bus 1504 may implement at least one of an Inter-Integrated Circuit (I2C) bus, a Serial Peripheral Interface (SPI) bus, a PCI bus, or a PCIe bus. Additionally or alternatively, the first bus 1504 may implement any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2_cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the L1 cache 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowcharts of FIGS. 4, 5 and/or 6 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4, 5, and/or 6. In particular, the FPGA 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4, 5, and/or 6. As such, the FPGA circuitry 1600 may be configured and/or structured to effectively instantiate some or all of the operations/functions corresponding to the machine readable instructions of the flowcharts of FIGS. 4, 5, and/or 6 as dedicated logic circuits to perform the operations/functions corresponding to those software instructions in a dedicated manner analogous to an ASIC. Therefore, the FPGA circuitry 1600 may perform the operations/functions corresponding to the some or all of the machine readable instructions of FIGS. 4, 5, and/or 6 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine readable instructions of FIGS. 4-6 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1312, 1412 of FIGS. 13-14, many other approaches are contemplated. For example, FPGA circuitry may include an on-board CPU, such as one or more of the example CPU 1620 of FIG. 16. Therefore, the programmable circuitry 1312, 1412 of FIGS. 13-14 may additionally be implemented by combining at least the example microprocessor 1500 of FIG. 15 and the example FPGA circuitry 1600 of FIG. 16. In some such hybrid examples, one or more cores 1602 of FIG. 16 may execute a first portion of the machine readable instructions represented by the flowchart(s) of FIGS. 4-6 to perform first operation(s)/function(s), the FPGA circuitry 1600 of FIG. 16 may be configured and/or structured to perform second operation(s)/function(s) corresponding to a second portion of the machine readable instructions represented by the flowcharts of FIG. 4-6, and/or an ASIC may be configured and/or structured to perform third operation(s)/function(s) corresponding to a third portion of the machine readable instructions represented by the flowcharts of FIGS. 4-6.

It should be understood that some or all of the circuitry of FIG. 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 3 may be implemented within one or more virtual machines and/or containers executing on the microprocessor 1500 of FIG. 15.

In some examples, the programmable circuitry 1312, 1412 of FIGS. 13-14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1312, 1412 of FIGS. 13-14 which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

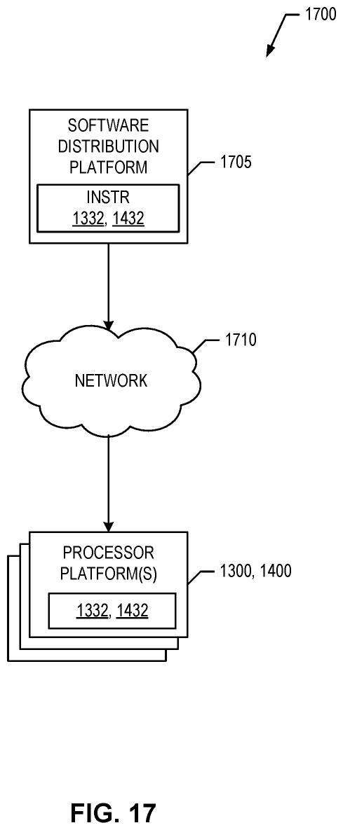

A block diagram illustrating an example software distribution platform 1705 to distribute software such as the example machine readable instructions 1332, 1432 of FIGS. 13-14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1312, 1412 of FIGS. 13-14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1312, 1412 of FIGS. 13-14, which may correspond to the example machine readable instructions of FIGS. 4-6, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1312, 1412 of FIGS. 13-14 from the software distribution platform 1705. For example, the software, which may correspond to the example machine readable instructions of FIG. 4-6, may be downloaded to the example programmable circuitry platform 1400, which is to execute the machine readable instructions 1432 to implement the deep feature warping generator circuitry 230. In some examples, one or more servers of the software distribution platform 1705 periodically offer, transmit, and/or force updates to the software (e.g., the example machine readable instructions 1312, 1412 of FIGS. 13-14) to ensure improvements, patches, updates, etc., are distributed and applied to the software at the end user devices. Although referred to as software above, the distributed “software” could alternatively be firmware.

From the foregoing, it will be appreciated that example systems, methods, apparatus, and articles of manufacture have been disclosed that permit improved computation and compression efficiency in distributed video analytics. For example, error residuals are periodically computed between warped deep features and initial features computed for a particular frame, such that the compression of flow information in combination with feature warping residuals provides better compression than for the key frames, at the cost of marginally higher complexity (e.g., due to additional flow and warping computation). Such an approach offers a richer tradeoff space over which to optimize computational complexity, compression efficiency, and/or task accuracy. Methods and apparatus disclosed herein assist with decoupling compute complexity and compression efficiency tradeoffs and provide enhanced performance over known approaches in terms of accuracy-rate-complexity characteristics. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for computation and compression efficiency in distributed video analytics are disclosed herein. Further examples and combinations thereof include the following:

Example 1 includes an apparatus comprising interface circuitry, machine readable instructions, and programmable circuitry to at least one of instantiate or execute the machine readable instructions to identify a key frame and a non-key frame in a video frame sequence input to a neural network at a client server, determine motion information between the key frame and the non-key frame based on optical flow, and determine a frame feature representation based on the motion information reconstructed at an edge server.

Example 2 includes the apparatus of example 1, wherein the programmable circuitry is to determine the frame feature representation based on feature warping.

Example 3 includes the apparatus of example 2, wherein the programmable circuitry is to perform the feature warping based on a bilinear interpolation function, the motion information to be used in an interpolation kernel of the bilinear interpolation function to determine the frame feature representation.

Example 4 includes the apparatus of example 1, wherein the programmable circuitry is to identify a sub-key frame of the video frame sequence and apply features of the sub-key frame in place of key frame features for subsequent non-key frames of the video frame sequence.

Example 5 includes the apparatus of example 4, wherein the programmable circuitry is to determine a residual error for the sub-key frame by subtracting flow-warped deep features from initial deep features determined for the non-key frame, the residual error based on the motion information.

Example 6 includes the apparatus of example 1, wherein the programmable circuitry is to compress the feature warping residual errors to determined compressed residual errors, and transmit the compressed residual errors to an edge server.

Example 7 includes the apparatus of example 1, wherein the programmable circuitry is to train a split neural network to process the key frame and the non-key frame in parallel.

Example 8 includes a method comprising identifying a key frame and a non-key frame in a video frame sequence input to a neural network at a client server, determining motion information between the key frame and the non-key frame based on optical flow, and determining a frame feature representation based on the motion information reconstructed at an edge server.

Example 9 includes the method of example 8, further including determining the frame feature representation using feature warping.

Example 10 includes the method of example 9, further including performing the feature warping using a bilinear interpolation function, the motion information used in an interpolation kernel of the bilinear interpolation function to reconstruct the frame feature representation.

Example 11 includes the method of example 8, further including identifying a sub-key frame of the video frame sequence and applying features of the sub-key frame in place of key frame features for subsequent non-key frames of the video frame sequence.

Example 12 includes the method of example 11, further including determining a residual error for the sub-key frame by subtracting flow-warped deep features from initial deep features determined for the non-key frame, the residual error based on the motion information.

Example 13 includes the method of example 8, further including compressing feature warping residual errors and transmit the residual errors to an edge server.

Example 14 includes the method of example 8, further including training a split deep neural network to process the key frame and the non-key frame in parallel.

Example 15 includes a non-transitory machine readable storage medium comprising instructions to cause programmable circuitry to at least identify a key frame and a non-key frame in a video frame sequence input to a neural network at a client server, determine motion information between the key frame and the non-key frame based on optical flow, and determine a frame feature representation based on the motion information reconstructed at an edge server.

Example 16 includes the non-transitory machine readable storage medium of example 15, wherein the instructions are to cause the programmable circuitry to determine the frame feature representation using feature warping.

Example 17 includes the non-transitory machine readable storage medium as defined in example 16, wherein the instructions are to cause the programmable circuitry to perform the feature warping using a bilinear interpolation function, the motion information used in an interpolation kernel of the bilinear interpolation function to reconstruct the frame feature representation.

Example 18 includes the non-transitory machine readable storage medium as defined in example 15, wherein the instructions are to cause the programmable circuitry to identify a sub-key frame of the video frame sequence and apply features of the sub-key frame in place of key frame features for subsequent non-key frames of the video frame sequence.

Example 19 includes the non-transitory machine readable storage medium as defined in example 18, wherein the instructions are to cause the programmable circuitry to determine a residual error for the sub-key frame by subtracting flow-warped deep features from initial deep features determined for the non-key frame, the residual error based on the motion information.

Example 20 includes the non-transitory machine readable storage medium as defined in example 15, wherein the instructions are to cause the programmable circuitry to compress feature warping residual errors and transmit the residual errors to an edge server.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
interface circuitry;
machine readable instructions; and
programmable circuitry to at least one of instantiate or execute the machine readable instructions to:
identify a key frame and a non-key frame in a video frame sequence input to a neural network at a client server;
determine motion information between the key frame and the non-key frame based on optical flow; and
determine a frame feature representation based on the motion information reconstructed at an edge server.

2. The apparatus of claim 1, wherein the programmable circuitry is to determine the frame feature representation based on feature warping.

3. The apparatus of claim 2, wherein the programmable circuitry is to perform the feature warping based on a bilinear interpolation function, the motion information to be used in an interpolation kernel of the bilinear interpolation function to determine the frame feature representation.

4. The apparatus of claim 1, wherein the programmable circuitry is to identify a sub-key frame of the video frame sequence and apply features of the sub-key frame in place of key frame features for subsequent non-key frames of the video frame sequence.

5. The apparatus of claim 4, wherein the programmable circuitry is to determine a residual error for the sub-key frame by subtracting flow-warped deep features from initial deep features determined for the non-key frame, the residual error based on the motion information.

6. The apparatus of claim 1, wherein the programmable circuitry is to:
compress the feature warping residual errors to determined compressed residual errors; and
transmit the compressed residual errors to an edge server.

7. The apparatus of claim 1, wherein the programmable circuitry is to train a split neural network to process the key frame and the non-key frame in parallel.

8. A method comprising:
identifying a key frame and a non-key frame in a video frame sequence input to a neural network at a client server;
determining motion information between the key frame and the non-key frame based on optical flow; and
determining a frame feature representation based on the motion information reconstructed at an edge server.

9. The method of claim 8, further including determining the frame feature representation using feature warping.

10. The method of claim 9, further including performing the feature warping using a bilinear interpolation function, the motion information used in an interpolation kernel of the bilinear interpolation function to reconstruct the frame feature representation.

11. The method of claim 8, further including identifying a sub-key frame of the video frame sequence and applying features of the sub-key frame in place of key frame features for subsequent non-key frames of the video frame sequence.

12. The method of claim 11, further including determining a residual error for the sub-key frame by subtracting flow-warped deep features from initial deep features determined for the non-key frame, the residual error based on the motion information.

13. The method of claim 8, further including compressing feature warping residual errors and transmit the residual errors to an edge server.

14. The method of claim 8, further including training a split deep neural network to process the key frame and the non-key frame in parallel.

15. A non-transitory machine readable storage medium comprising instructions to cause programmable circuitry to at least:
identify a key frame and a non-key frame in a video frame sequence input to a neural network at a client server;
determine motion information between the key frame and the non-key frame based on optical flow; and
determine a frame feature representation based on the motion information reconstructed at an edge server.

16. The non-transitory machine readable storage medium of claim 15, wherein the instructions are to cause the programmable circuitry to determine the frame feature representation using feature warping.

17. The non-transitory machine readable storage medium as defined in claim 16, wherein the instructions are to cause the programmable circuitry to perform the feature warping using a bilinear interpolation function, the motion information used in an interpolation kernel of the bilinear interpolation function to reconstruct the frame feature representation.

18. The non-transitory machine readable storage medium as defined in claim 15, wherein the instructions are to cause the programmable circuitry to identify a sub-key frame of the video frame sequence and apply features of the sub-key frame in place of key frame features for subsequent non-key frames of the video frame sequence.

19. The non-transitory machine readable storage medium as defined in claim 18, wherein the instructions are to cause the programmable circuitry to determine a residual error for the sub-key frame by subtracting flow-warped deep features from initial deep features determined for the non-key frame, the residual error based on the motion information.

20. The non-transitory machine readable storage medium as defined in claim 15, wherein the instructions are to cause the programmable circuitry to compress feature warping residual errors and transmit the residual errors to an edge server.
